(19) United States
(12) Patent Application Publication
(10) Pub. No.: US 2012/0098173 A1
(43) Pub. Date: Apr. 26, 2012

(54) Rebound Control Enhancement For Air Springs

(75) Inventor: Michael L. Crabtree, Arvada, CO (US)

(73) Assignee: VIBRACOUSTICS NORTH AMERICA, L.P., Plymouth, MI (US)

(21) Appl. No.: 12/912,415

(22) Filed: Oct. 26, 2010

(51) Int. Cl. F16F 9/05

(52) U.S. Cl. 267/124

(57) ABSTRACT

An air spring including a piston, and a flexible sleeve connected to the piston. The flexible sleeve forms a compression chamber and includes a lobe that rolls along a surface of the piston during compression of the flexible sleeve. The flexible sleeve is connected to the piston by an inverted crimp connection. A crimp ring used providing the inverted crimp connection includes a rebound travel limiter around which the lobe is formed.

### FIELD

The present disclosure relates to an air spring with enhanced rebound control.

### BACKGROUND

The statements in this section merely provide background information related to the present disclosure and may not constitute prior art.

The function of a vehicle suspension is to control input forces and resulting displacements to achieve desired vibration isolation, natural frequency, impact feel, or transition to suspension hard stops. Tuning of springs, dampers, jounce bumpers and rebound bumpers together are typically necessary to obtain a compromise of all performance requirements. One area of particular difficulty is the transition to suspension hard stops in extremes of jounce or rebound travel. This is referred to as “bottoming” (jounce) or “topping” (rebound). When optimizing a suspension performance, trying to maintain good vibration isolation and good entry feel to topping or bottoming bumpers normally results in a compromise for all three characteristics—overall spring rate must be increased in order to improve entry feel—but this hurts vibration isolation. The competing effects are that the low spring rate required for good vibration isolation results in high end loads in rebound or high displacements in jounce. The transition to these end conditions must be well controlled or a harsh stop at the end of wheel travel (for a passenger car suspension) will be the result. This is why suspension systems utilize highly tuned jounce bumpers and rebound bumpers.

In FIG. 4, the dashed line represents a force curve for a spring with a high spring rate—poor for vibration isolation but good for topping and bottoming. The solid line represents a force curve for a spring with a low spring rate for good vibration isolation but bad for topping and bottoming. For the high spring rate curve, the force level of the low spring rate curve is achieved at much lower deflection—thus controlling bottoming better. On the rebound side, the “tail load” of the low spring rate curve is higher than that of the high spring rate curve. This results in harsh and loud impact at full extension—topping (see FIG. 5).

Air springs are commonly used for motor vehicles, various machines, and other equipment. The air springs are designed to support a suspension load. The air springs are often combined with a separate shock absorber device in the suspension that functions to dampen oscillations. As shown in FIGS. 9-11, air springs generally consist of a flexible elastomeric reinforced sleeve 100 that extends between a pair of end members 102, 104. The sleeve 100 is attached to the end members 102, 104 by crimp rings 106, 108 to form a pressurized chamber 110 therein.

During operation of the air spring, the flexible sleeve 100 will compress to adjust a volume of the pressurized chamber 106. To accommodate this flexing, the sleeve 100 will form lobes 112, as the sleeve is compressed, that roll along surfaces of the end members 102, 104.

It has long been a goal of air spring designers to achieve a blend of the two curves so that much less compromise was needed. In essence, the ideal air spring force deflection curve would have a low spring rate in the middle portion of the curve that transitioned to a high spring rate at the ends. Both air spring piston shaping and air sleeve shaping have been used to achieve this, but success has been very marginal and too expensive. The jounce portion of the force curve has actually been very well handled. It is the rebound portion of the force curve that presents additional challenge which needs to be addressed.

The force-deflection curve of FIG. 6 shows a typical characteristic shape for an air spring having a piston 104′ with straight sidewalls. The force-deflection curve is non-linear with upward curvature due to the polytropic nature of air compression. The spring rate increase in jounce (progressivity) is helpful for controlling bottoming, but typically, a flare 114 at the base of the piston 104″ can be added to increase progessivity and gain even more bottoming control (FIG. 7). The flare 114 increases the area acted on by the pressure in the spring and thus produces more force.

### SUMMARY

With the above need in mind, the present teachings provide an air spring including a piston, and a flexible sleeve connected to the spring seat. The flexible sleeve forms a compression chamber and includes a lobe that rolls along a surface of the piston during compression of the flexible sleeve. The flexible sleeve is connected to the piston by an inverted crimp connection. The inverted crimp connection between the piston and the flexible sleeve includes an end of the sleeve being folded inward so that an exterior surface of the flexible sleeve is disposed against an outer surface of the piston and a crimp ring engages an outwardly facing interior surface of the flexible sleeve to secure the flexible sleeve to the piston.

The lower crimp ring can be provided with an outwardly curved portion that serves as a rebound travel limiter that can be specifically designed to tune the rebound response of the air spring.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a cross-sectional view of an air spring according to the present teachings;

FIG. 2 is a cross-sectional view of the air spring of FIG. 1 shown in an extended position;

FIG. 3 is a detailed cross-sectional view of the inverted crimp connection between the flexible sleeve and piston according to the principles of the present disclosure;

FIG. 4 is an illustrative force curve for a spring in jounce and rebound;

FIG. 5 is an illustrative force curve for a spring in jounce and rebound;

FIG. 6 is an illustrative force curve for a prior art air spring;

FIG. 7 is an illustrative force curve for a second prior art air spring;

FIG. 8 is a comparative force curve for the prior art air spring and the air spring of the present disclosure;

FIG. 9 is a cross-sectional view of a prior art air spring;

FIG. 10 is a cross-sectional view of the prior art air spring of FIG. 9 in an extended state;

FIG. 11 is a detailed cross-sectional view of the prior art reverse fold crimp connection between the flexible sleeve and piston; and

FIG. 12 is a detailed cross-sectional view of the inverted crimp connection between the flexible sleeve and piston similar to FIG. 3 with the rebound travel limiter removed.

### DETAILED DESCRIPTION

The following description is merely exemplary in nature and is not intended to limit the present disclosure, application, or uses. It should be understood that throughout the drawings, corresponding reference numerals indicate like or corresponding parts and features.

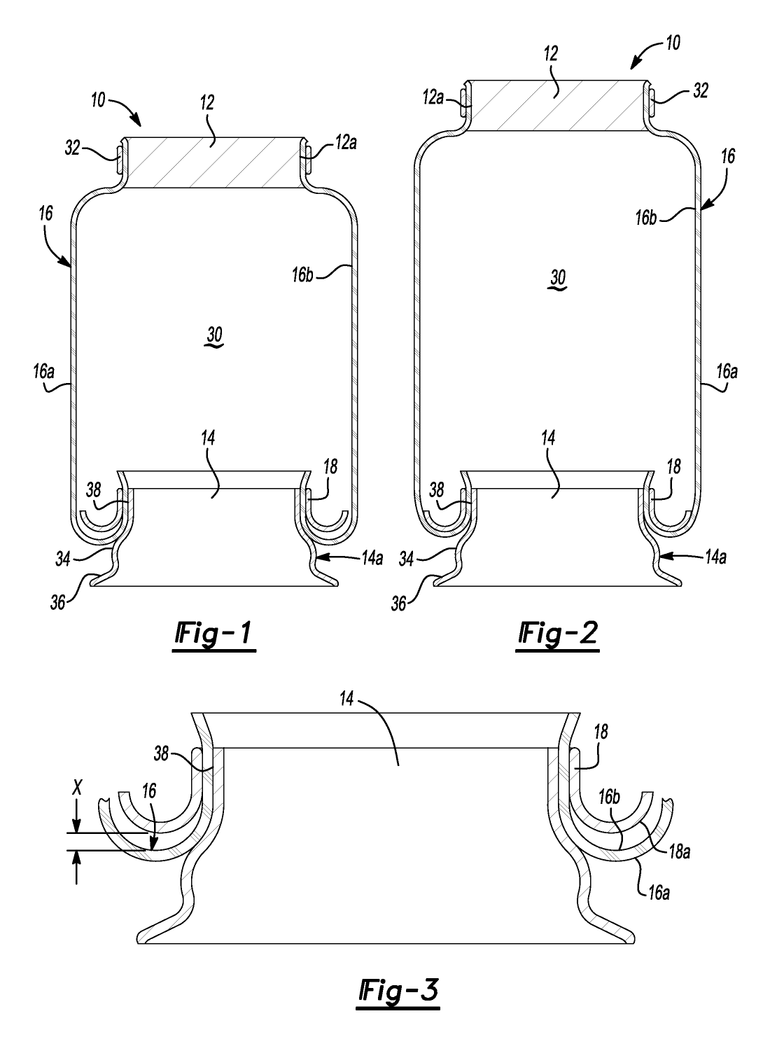

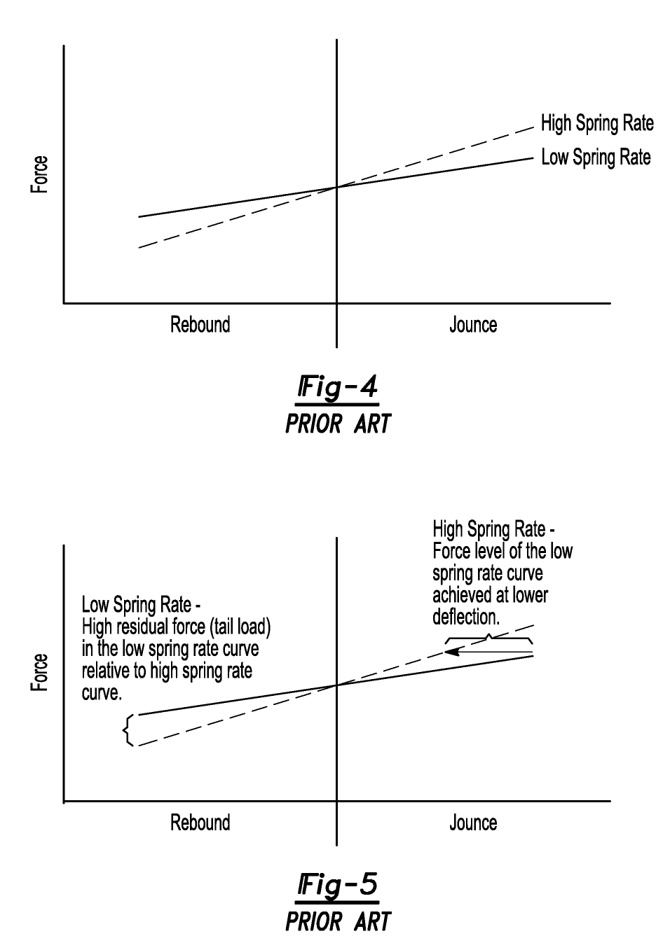

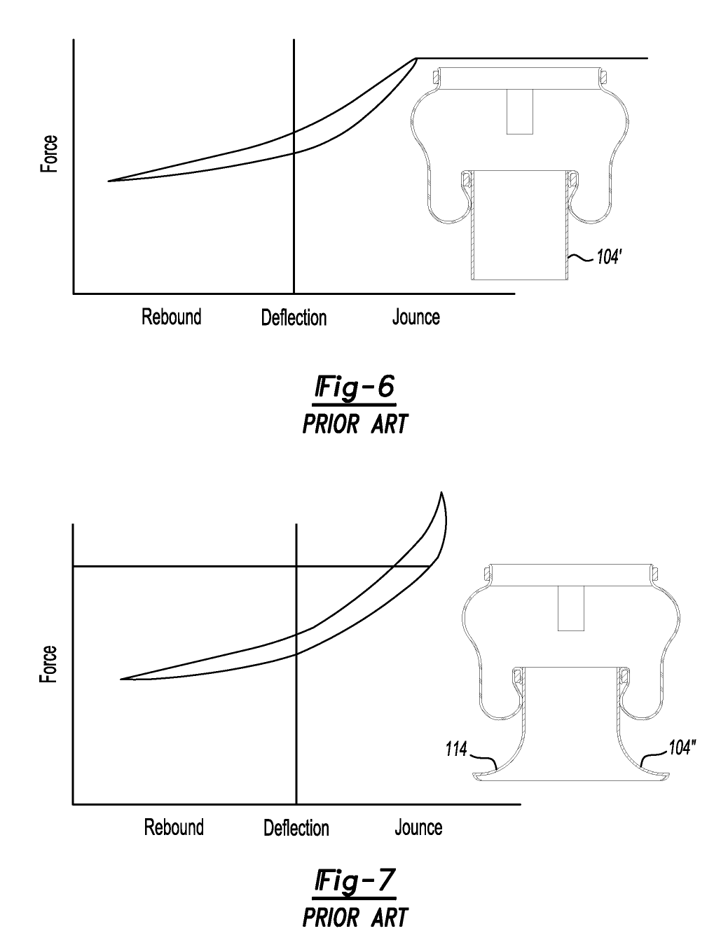

Referring to FIGS. 1-3, the air spring device 10 of the present teachings will now be described. As shown in the figures, the air spring device 10 generally includes an upper end cap 12 and a lower piston 14. Connecting the upper end cap 12 and the lower piston 14 is a flexible sleeve 16 that forms a compression chamber 30. A lobe travel limiter ring 18 retains the flexible sleeve 16 to the lower piston 14.

Although in the embodiments shown, the piston 14 is shown connected to the lower end of the sleeve 16, it should be understood that the piston 14 could be disposed at the upper end and the end cap 12 could be disposed at the lower end of the flexible sleeve 16.

The end cap 12 is provided with an annular outer surface 12A to which an upper end of the sleeve 16 is clamped by a clamp ring 32. The piston 14 can include a radially outer surface 14A that can have a stepped portion 34 and a radially outwardly flared portion 36 against which the lobe on the flexible sleeve rolls along during compression and extension of the air spring 10. The piston 14 also includes a cylindrical upper portion 38 which is attached to the flexible sleeve 16. In particular, the flexible sleeve 16 is connected to the piston 14 by an inverted crimp connection as best illustrated in FIG. 3. The flexible sleeve 16 includes an exterior surface 16a and an interior surface 16b disposed on the compression chamber side of the flexible sleeve 16. The inverted crimped connected between the flexible sleeve 16 and the cylindrical surface 38 of piston 14 includes the end of the sleeve 16 being folded inward so that the exterior surface 16a of the flexible sleeve is disposed against the cylindrical surface 38 of the piston 14 and the crimp ring 18 engages an outwardly facing interior surface 16b of the flexible sleeve to secure the flexible sleeve to the piston 14.

The crimp ring 18 can optionally be provided with a radially outwardly curved and upwardly extending portion 18A that extends from the crimp ring 18 and serves as a rebound travel limiter around which a lower lobe of the sleeve 16 is formed. The rebound travel limiter has a radius of curvature that extends axially downward from the crimp ring 18 in a direction away from the end cap 12. The rebound travel limiter 18A then curves outward and upward back toward the end cap 12. With reference to FIG. 3, the distance X between the lower lobe of the sleeve 16 and the rebound travel limiter 18A can be adjusted to provide a desired rebound affect. By reducing the distance X, the sleeve 16 goes into tensile force quicker and by increasing the distance X, the sleeve 16 goes into tensile force slower. The distance X is therefore, chosen to provide a desired rebound characteristic for the intended use. As shown in FIG. 12, the rebound travel limiter portion can be optionally omitted from the crimp ring 18′ while the inverted crimp connection still provides an improved rebound performance as compared to the prior art design.

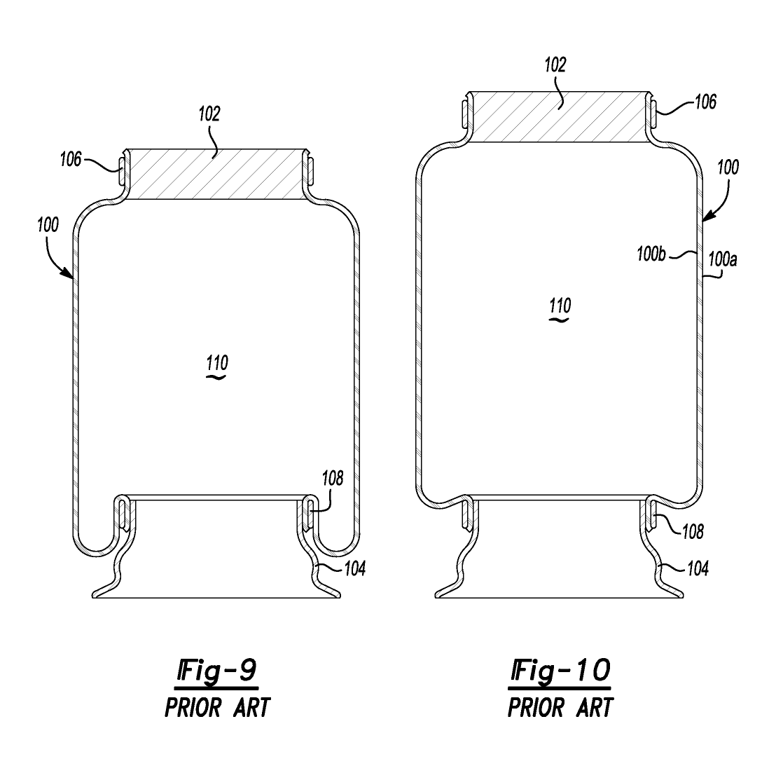

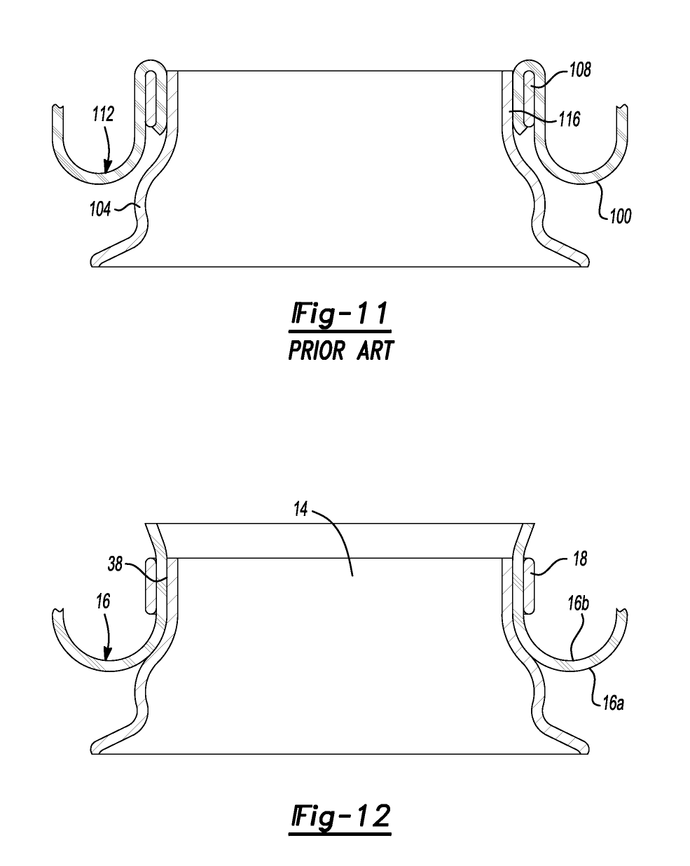

The inverted crimp connection of the present disclosure differs from prior art designs which use a reverse fold crimp connection as illustrated in FIGS. 9-11. In FIGS. 9-11, a spring seat 12 and piston 14 are provided in the same manner as described above with respect to the present disclosure. The flexible sleeve 16′ is connected to the spring seat 102 in generally the same manner as described above utilizing a clamp ring 106. In the crimp connection as illustrated in FIG. 11, the flexible sleeve 100 is clamped between crimp ring 108 such that the interior surface 100B is disposed against a cylindrical portion 116 of the piston 104 and the ring 108 is disposed against the exterior surface 100A of the flexible sleeve 100. Then, the flexible sleeve 100 is folded over top of the exterior surface of the crimp ring 108 so as to form a lobe extending over top of the crimp ring 108 and along the exterior surface of the piston 104.

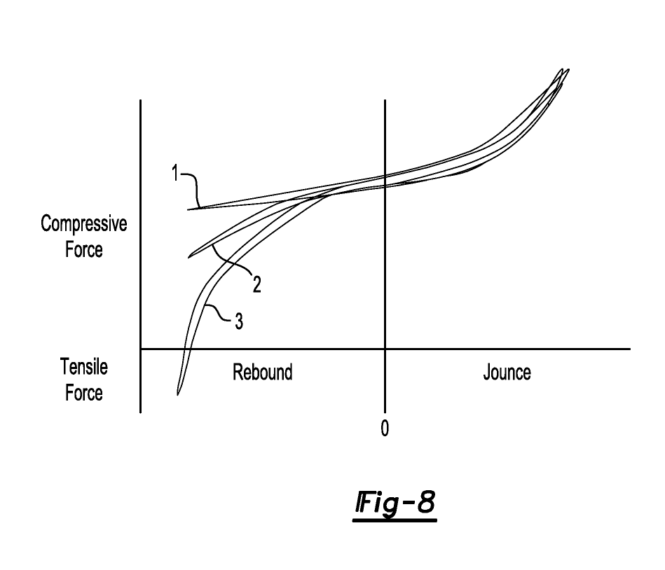

With reference to FIG. 8, the comparative force curves are shown wherein curve 1 represents the typical air spring force-deflection curve while curve 2 shows the marginal success achieved with piston sleeve modifications to increase the rebound spring rate. Curve 3 shows the force curve of the air spring provided with an inverted crimp connection to the piston and a rebound travel limiter as discussed above with reference to FIGS. 1-3. FIG. 3 illustrates that with the present design, the air spring can achieve tensile loads during rebound where the other two springs still have compressive loads. The level of rebound spring rate increase shown for curve 3 in FIG. 8 is achieved by inverting the crimp connection on the piston and adding a rebound travel limiter. This causes the air spring to convert from a compressive load device to a tensile load device with far less deflection than a conventionally assembled air spring with a reverse fold crimp connection as is known in the prior art. The benefit is greatly enhanced rebound control, elimination of topping, elimination of additional dampers and rebound bumpers. Another change takes place as well when the air spring assembly converts to a tension device. Extension movements are now decreasing volume deflections instead of an increasing volume deflection as occurs with the prior art design. As such, the air pressure inside the air spring stays constant or increases which thereby increases the spring rate of the rebound travel even more.

The air spring with a prior art reverse fold crimp will require much greater rebound travel before converting from a compressive load device to a tensile load device. The volume of the spring will also increase, resulting in the pressure decreasing and thereby no added effect. The additional travel to “unroll” the lobe can be as much as 30 millimeters. Upon rebound deflections, the spring with the inverted crimp connection, according to the principles of the present disclosure, will begin to develop a tensile load with very little, but specified, travel into rebound. The volume of the spring will also decrease with more extension keeping internal pressure constant or increasing, adding to the tensile load. Because the load does not “unroll,” tensile load can be developed as much as 30 millimeters sooner into rebound travel.

The air spring of the present disclosure provides a new way to use an air spring to achieve greater control of rebound deflection and forces in an air spring suspension. This approach can be applied to any air suspension that uses a rolling lobe air spring. Additionally, the added feature of maintaining or increasing air spring internal pressure as the spring extends will have a direct benefit to increasing air damping.

The description of the present teachings is merely exemplary in nature and, thus, variations that do not depart from the gist of the present teachings are intended to be within the scope of the present teachings. Such variations are not to be regarded as a departure from the spirit and scope of the present teachings.

What is claimed is:

1. An air spring comprising:
a piston;
a flexible sleeve connected to said piston, said flexible sleeve forming a compression chamber and including a lobe that rolls along a surface of said piston during compression of said flexible sleeve; and
said flexible sleeve being connected to said piston by an inverted crimp connection using a crimp ring.

2. The air spring of claim 1, wherein said surface of said piston is flared outwardly.

3. The air spring of claim 1, further comprising a rebound travel limiter extending radially outward from said crimp ring.

4. The air spring of claim 1, further comprising a rebound travel limiter extending radially outward and downward from said crimp ring.

5. The air spring of claim 1, further comprising a rebound travel limiter extending radially outward and downward from said crimp ring and curving axially back toward the crimp ring.

6. An air spring comprising:
a piston;
an end cap;
a flexible sleeve connecting said piston and said end cap, said flexible sleeve forming a compression chamber and including lobes that roll along an outer surface of said piston during compression of said flexible sleeve, wherein said flexible sleeve includes an exterior surface and an interior surface and said flexible sleeve includes an end of the sleeve being folded inward so that said exterior surface of the flexible sleeve is disposed against said outer surface of said piston and a clamp ring engages an outwardly facing interior surface of said flexible sleeve to secure said flexible sleeve to said piston.

7. The air spring of claim 6, wherein said surface of said piston is flared outwardly.

8. The air spring of claim 6, further comprising a rebound travel limiter extending radially outward from said crimp ring.

9. The air spring of claim 6, further comprising a rebound travel limiter extending radially outward and downward from said crimp ring.

10. The air spring of claim 6, further comprising a rebound travel limiter extending radially outward and downward from said crimp ring and curving axially back toward the crimp ring.
